(19) United States
(12) Patent Application Publication
(10) Pub. No.: US 2003/0005443 A1
(43) Pub. Date: Jan. 2, 2003

(54) EPG having PIP window history and sample view functionality

(76) Inventors: Karin Axelsson, Linkoping (SE); Marcus Bernhardson, Linkoping (SE); Conny Forsander, Linkoping (SE); Fredrik Paulsson, Linkoping (SE)

Correspondence Address: ANTONELLI TERRY STOUT AND KRAUS, SUITE 1800, 1300 NORTH SEVENTEENTH STREET, ARLINGTON, VA, 22209

(21) Appl. No.: 09/891,379

(22) Filed: Jun. 27, 2001

(51) Int. Cl. H04N 5/445

(52) U.S. Cl. 725/46; 725/45; 725/58

(57) ABSTRACT

The present invention provides an electronic program guide system associated with a broadcast receiver in a broadcast system, said electronic program guide system comprising: receiving means for receiving at least one electronic program guide corresponding to the broadcast system; first display generation means for generating display of said electronic program guide in a first display area of a display unit associated with said broadcast receiver; selecting means for selecting a desired program from said electronic program guide; tuning means for controlling a tuner of the associated broadcast receiver to tune to the selected program; second display generation means for generating display of the selected program in a second display area of said display unit; and storage means for storing parameters identifying said selected program; and wherein additional program selections causes tuning and display of the additionally selected programs in the second display area and addition of parameters identifying the additionally selected programs to the storage means.

### FIELD OF INVENTION

The present invention generally relates to an electronic program guide system. More particularly it relates to channel selection by means of a picture-in-picture area in an electronic program guide.

### BACKGROUND

Many magazines, newspapers, and other publications have built their readership around the growing market of television (TV) viewers, who desire TV program information. Many cable TV networks have even designated a TV channel for providing the date, time and channel, at which TV programs will be presented.

An expedient presentation of TV program information is obtained by an electronic program guide (EPG). In an EPG it is possible to browse, in a simple matter, a multitude of programs provided from a multitude of TV channels. An Electronic Program Guide (EPG) is an application provided in an apparatus such as an integrated receiver decoder (IRD), a set-top box (STB), or television receiver, designed to aid a viewer in the navigation of and selection from broadcast services in a digital television system. By means of the EPG it is possible to control the functionality of the apparatus, such as tuning to, or scheduling a recording of a specific service.

A further facility for browsing TV programs in an EPG is a picture-in-picture (PIP) area displaying a TV program in a small part of a full screen. When the EPC is entered one area displays program information and another area displays the program watched when entering the EPG as a PIP.

By selecting another program from the EPG that program is displayed in the PIP area. It is possible to return to the last channel viewed full screen, as is described in the international publication WO9734414.

A drawback with the returning possibility described in WO9734414 is that if a user has displayed several programs in the PIP area he may only revert to the last channel viewed in full screen.

When viewing programs in a PIP area of an EPG it is difficult to know when something interesting is shown in the originally shown program. Thus, another drawback with PIP in EPG is that the user risk missing something interesting in the program originally watched.

### SUMMARY OF THE INVENTION

An object of the present invention is to provide an electronic program guide that overcomes the above-mentioned drawbacks.

Another object of the present invention is to provide a method that overcomes the above-mentioned drawbacks.

Yet another object of the present invention is to provide a computer program product that overcomes the above-mentioned drawbacks.

These objects, among others, are according to the present invention attained by electronic program guides, methods and computer program products, respectively, as defined in the appended claims.

By providing an electronic program guide system associated with a broadcast receiver in a broadcast system, said electronic program guide system comprising: receiving means for receiving at least one electronic program guide corresponding to the broadcast system; first display generation means for generating display of said electronic program guide in a first display area of a display unit associated with said broadcast receiver; selecting means for selecting a desired program from said electronic program guide; tuning means for controlling a tuner of the associated broadcast receiver to tune to the selected program; second display generation means for generating display of the selected program in a second display area of said display unit; and storage means for storing parameters identifying said selected program; and wherein additional program selections causes tuning and display of the additionally selected programs in the second display area and addition of parameters identifying the additionally selected programs to the storage means, all temporarily viewed programs in the second display area may easily be reverted to for viewing.

By providing an electronic program guide system associated with a broadcast receiver in a broadcast system, said electronic program guide system comprising: receiving means for receiving at least one electronic program guide corresponding to the broadcast system; first display generation means for generating display of said electronic program guide in a first display area of a display unit associated with said broadcast receiver; selecting means for selecting a desired program from said electronic program guide; tuning means for controlling a tuner of the associated broadcast receiver to tune to the selected program; second display generation means for generating display of the selected program in a second display area of said display unit; storage means for storing parameters identifying said selected program; and timer means; wherein an additional program selection causes tuning and display of the additionally selected program in the second display area and wherein said timer means is activated upon additional program selection and causes tuning and display of the additionally selected program in the second display area of the display unit for a predetermined time and renewed tuning and display of the previously selected program in the second display area of the display unit upon elapse of the predetermined time, a user will not miss out much of a program viewed when temporarily displaying another program in the second display area.

By providing a method for browsing programs selected for display in a second display area of an electronic program guide system associated with a broadcast receiver comprising the steps of: receiving at least one electronic program guide corresponding to a broadcast system; generating display of said electronic program guide in a first display area of a display unit associated with said broadcast receiver; selecting a desired program from said electronic program guide; controlling a tuner of the associated broadcast receiver to tune to the selected program; generating display of the selected program in the second display area of said display unit; storing parameters identifying said selected program; repeating the controlling, generating and storing steps for each subsequently made program selection, all temporarily viewed programs in the second display area may easily be reverted to for viewing.

By providing a method for browsing programs selected for display in a second display area of an electronic program guide system associated with a broadcast receiver comprising the steps of: receiving at least one electronic program guide corresponding to a broadcast system; generating display of said electronic program guide in a first display area of a display unit associated with said broadcast receiver; selecting a desired program from said electronic program guide; controlling a tuner of the associated broadcast receiver to tune to the selected program; generating display of the selected program in the second display area of said display unit; storing parameters identifying said selected program; activating timer means upon additional program selection; controlling a tuner of the associated broadcast receiver to tune to the additionally selected program for a predetermined time; generating display of the additionally selected program in the second display area of said display unit for the predetermined time; controlling the tuner of the associated broadcast receiver to tune to the previously selected program upon elapse of the predetermined time; generating display of the previously selected program in the second display area of said display unit upon elapse of the predetermined time, a user will not miss out much of a program viewed when temporarily displaying another program in the second display area.

By providing a computer program product stored on a computer readable storage medium, comprising computer readable program code means for causing a computer to perform the following steps: receiving at least one electronic program guide corresponding to a broadcast system; generating display of said electronic program guide in a first display area of a display unit; providing for selection of a desired program from said electronic program guide; controlling a tuner of an associated broadcast receiver to tune to the selected program; generating display of the selected program in the second display area of said display unit; storing parameters identifying said selected program; providing for selection of an additional program from said electronic program guide; repeating the controlling, generating and storing steps for each subsequent program selection; providing for selection of stored parameters identifying a previously selected program; controlling a tuner of the associated broadcast receiver to tune to the program identified by the selected parameters; generating display of the program identified by the selected parameters in the second display area of said display unit, all temporarily viewed programs in the second display area may easily be reverted to for viewing.

By providing a computer program product directly loadable into the internal memory of a digital computer comprising software code portions for performing the following steps when said product is run on a computer: receiving at least one electronic program guide corresponding to a broadcast system; generating display of said electronic program guide in a first display area of a display unit; providing for selection of a desired program from said electronic program guide; controlling a tuner of an associated broadcast receiver to tune to the selected program; generating display of the selected program in the second display area of said display unit; storing parameters identifying said selected program; providing for selection of an additional program from said electronic program guide; repeating the controlling, generating and storing steps for each subsequent program selection; providing for selection of stored parameters identifying a previously selected program; controlling a tuner of the associated broadcast receiver to tune to the program identified by the selected parameters; generating display of the program identified by the selected parameters in the second display area of said display unit, all temporarily viewed programs in the second display area may easily be reverted to for viewing,

Further features and advantages of the present invention will be evident from the following description.

### BRIEF DESCRIPTION OF THE DRAWINGS

The present invention will become more fully understood from the detailed description of embodiments given below and the accompanying figures, which are given by way of illustration only, and thus, are not limitative of the present invention, wherein:

FIG. 1 schematically shows a first embodiment of the present invention;

FIG. 2 schematically shows a second embodiment of the present invention; and

FIG. 3 schematically shows a third embodiment of the present invention.

### DETAILED DESCRIPTION OF EMBODIMENTS

In the following description, for purpose of explanation and not limitation, specific details are set forth, such as particular techniques and applications in order to provide a thorough understanding of the present invention. However, it will be apparent for a person skilled in the art that the present invention may be practiced in other embodiments that depart from these specific details. In other instances, detailed description of well-known methods and apparatuses are omitted so as not to obscure the description of the present invention with unnecessary details.

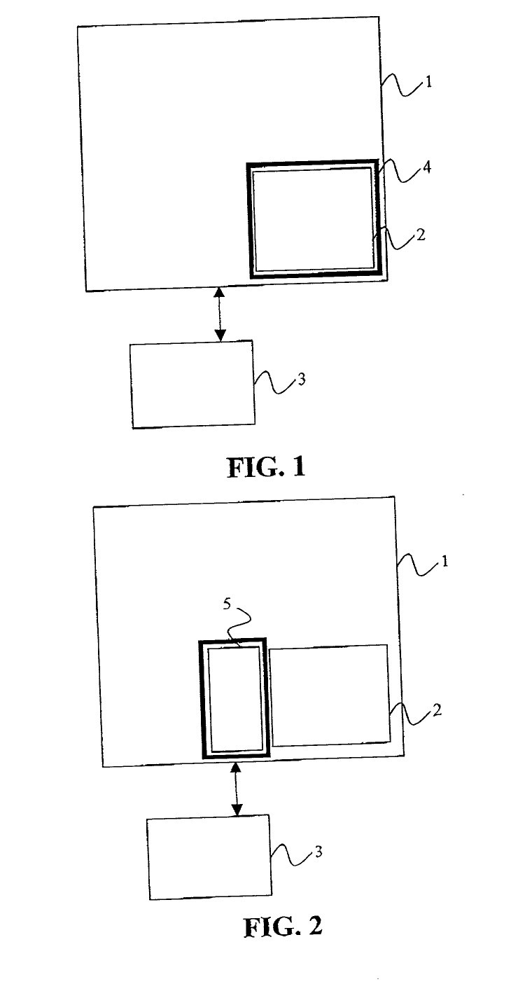

A first embodiment of the present invention will now be described with reference to FIG. 1.

An electronic program guide (EPG) system 1 associated with a broadcast receiver in a broadcast system is displayed in a first display area on a display unit, such as a TV set. The EPG system 1 comprises receiving means for receiving at least one electronic program guide corresponding to the broadcast system and first display generation means for generating display of the EPG in the first display area of the associated display unit. The EPG system 1 further includes a picture-in-picture (PIP) area, hereafter referred to as second display area 2, displaying the program that was shown in full screen when the EPG was entered. The EPG has access to a history memory, hereafter referred to as storage means 3 that register parameters identifying programs displayed in the second display area 2, such as the program that was showed in full screen when the EPG was entered.

Using selecting means, such as e.g. a remote control unit (RC), selection of a new, desired program can be made from the EPG. Tuning to this program is affected by tuning means for controlling a tuner of the associated broadcast receiver to tune to the selected program. Display of this program is generated by second display generation means generating display of the selected program in the second display area 2 of the display unit. Parameters identifying the selected program are stored in the storage means 3. This process may be repeated a plurality of times, wherein each program displayed in the second display area 2 is registered to the storage means.

To browse between the programs registered in the storage means 3 selection of the second display area 2 is allowed 4, e.g. by moving a cursor on the display unit or by jumping between selectable areas on the display unit using first input means, such as a remote control unit. A program, different from the one being displayed in the second display area 2, is selected by pushing e.g. a “previous program” or “next program” button on the first input means.

When a desired program is displayed in the second display area 2 second input means, such as an activation button can be pressed returning the system to full screen view display of the program previously displayed in the second display area 2.

A second embodiment of the present invention will next be described with reference to FIG. 2.

This second embodiment of the present invention is identical to the first embodiment of the present invention apart from that the EPG 1 comprises a history area, hereafter referred to as third display area 5 displaying a history list of the programs registered in the storage means 3 and browsing the storage means 3 is achieved by selecting the third display area 5 as the second display area 2 was selected according to the first embodiment. When a program in the history list comprised in the storage means is activated by means of third input means this program is displayed in the second display area 2. If a program is activated in the history list by means of fourth input means and already is displayed in the second display area 2 that program is displayed in full screen viewing.

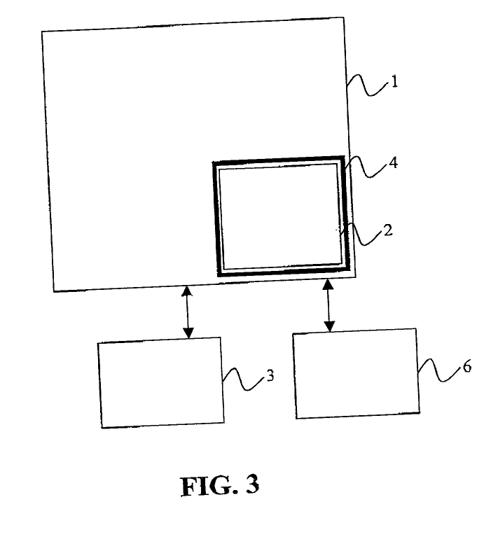

A third embodiment of the present invention will next be described with reference to FIG. 3.

An electronic program guide (EPG) is displayed on a display unit, such as a TV set, by a EPG system 1. The EPG system 1 includes a picture-in-picture (PIP) area, hereafter referred to as second display area 2 showing the program that was showed in full screen when the EPG was entered. The EPG has access to a history memory, hereafter referred to as storage means 3 that registers the first program displayed in the second display area 2 when entering the EPG.

By selecting a sample view of a new program from the EPG, this program is displayed in the second display area 2. The EPG system 1 has access to timer means 6, which is activated when a program replaces the first program displayed in the second display area 2 when entering the EPG. The timer means 6 are set to elapse in a predetermined time, preferably between 5-15 seconds.

Sample views of programs may be displayed in the second display area 2 but when the timer means 6 has elapsed the first program, registered in the storage means 3, is redisplayed in the second display area 2. In this way the user need not miss out much of the initially viewed program.

If a sample view of a desired program is displayed in the second display area 2, before the timer means 6 has elapsed, an activation button may be pressed as fifth input means, when the second display area 2 is marked 4, returning the system to full screen viewing displaying the program previously displayed in the second display area 2, and also resetting the timer means 6.

This third embodiment may be combined with the first or second embodiments providing the possibility to browse the history memory storage means by marking the second display area or third display area. Preferably, programs may be displayed in two different modes in the second display area 2 in either of such combined embodiments. In a first mode a sample of a program in the EPG 1 may be viewed in the second display area 2 activating the timer means 6 as described above. In a second mode the program may be viewed in the second display area 2 without activating the timer means 6. The choice between the two different modes is preferably obtained by displaying to the user of the EPG a message when a program is selected in the EPG, which message gives two selectable choices: sample view on or sample view off, or alternatively timer on or timer off.

The electronic program guide system described above may be incorporated in e.g. an integrated receiver decoder, a set-top box, a mobile handset, a television receiver or a mobile display appliance.

The present invention may be implemented as a computer program product stored on a computer readable storage medium, comprising computer readable program code means for causing a computer to perform the features described above.

Such a computer program product may be directly loadable into the internal memory of a digital computer comprising software code portions for performing the features described above when said product is run on a computer.

It will be obvious that the present invention may be varied in a plurality of ways. Such variations are not to be regarded as a departure from the scope of the present invention. All such variations as would be obvious for a person skilled in the art are intended to be included within the scope of the present invention.

1. An electronic program guide system associated with a broadcast receiver in a broadcast system, said electronic program guide system comprising:
receiving means for receiving at least one electronic program guide corresponding to the broadcast system;
first display generation means for generating display of said electronic program guide in a first display area of a display unit associated with said broadcast receiver; selecting means for selecting a desired program from said electronic program guide;
tuning means for controlling a tuner of the associated broadcast receiver to tune to the selected program;
second display generation means for generating display of the selected program in a second display area of said display unit; and
storage means for storing parameters identifying said selected program; and wherein additional program selections causes tuning and display of the additionally selected programs in the second display area and addition of parameters identifying the additionally selected programs to the storage means.

2. The electronic program guide system as claimed in claim 1, further comprising first input means allowing selection of stored parameters identifying a previously selected program, wherein said selection causes tuning and display of the previously selected program in the second display area of the display unit.

3. The electronic program guide system as claimed in claim 1, further comprising second input means allowing selection of the program currently being displayed in the second display area of the display unit for full screen display.

4. The electronic program guide system as claimed in claim 1, further comprising third display generation means for generating display of a list of the programs stored in the storage means in a third display area of the display unit.

5. The electronic program guide system as claimed in claim 2, wherein said first input means allows for stepwise sequential selection of the stored parameters.

6. The electronic program guide system as claimed in claim 4, further comprising third input means for allowing selection of a program from said list, wherein said selection causes tuning and display of the selected program in the second display area of the display unit.

7. The electronic program guide system as claimed in claim 4, further comprising fourth input means for allowing selection from said list of a program currently being displayed in the second display area of the display unit, wherein said selection causes full screen display of the selected program on the display unit.

8. The electronic program guide system as claimed in claim 1, further comprising timer means, wherein said timer means is activated upon program selection and causes tuning and display of the selected program in the second display area of the display unit for a predetermined time and renewed tuning and display of the previously selected program in the second display area of the display unit upon elapse of the predetermined time.

9. The electronic program guide system as claimed in claim 8, further comprising fifth input means for allowing selection of the program being displayed in the second display area of the display unit for the predetermined time, wherein said selection causes full screen display of the selected program on the display unit.

10. The electronic program guide system as claimed in claim 1, wherein said electronic program guide system is incorporated in an integrated receiver decoder.

11. The electronic program guide system as claimed in claim 1, wherein said electronic program guide system is incorporated in a set-top box.

12. The electronic program guide system as claimed in claim 1, wherein said electronic program guide system is incorporated in a mobile handset.

13. The electronic program guide system as claimed in claim 1, wherein said electronic program guide system is incorporated in a television receiver.

14. The electronic program guide system as claimed in claim 1, wherein said electronic program guide system is incorporated in a mobile display appliance.

15. An electronic program guide system associated with a broadcast receiver in a broadcast system, said electronic program guide system comprising:
receiving means for receiving at least one electronic program guide corresponding to the broadcast system;
first display generation means for generating display of said electronic program guide in a first display area of a display unit associated with said broadcast receiver;
selecting means for selecting a desired program from said electronic program guide;
tuning means for controlling a tuner of the associated broadcast receiver to tune to the selected program;
second display generation means for generating display of the selected program in a second display area of said display unit;
storage means for storing parameters identifying said selected program; and
timer means; wherein an additional program selection causes tuning and display of the additionally selected program in the second display area and wherein said timer means is activated upon additional program selection and causes tuning and display of the additionally selected program in the second display area of the display unit for a predetermined time and renewed tuning and display of the previously selected program in the second display area of the display unit upon elapse of the predetermined time.

16. The electronic program guide system as claimed in claim 15, further comprising fifth input means for allowing selection of the program being displayed in the second display area of the display unit for the predetermined time, wherein said selection causes full screen display of the selected program on the display unit.

17. The electronic program guide system as claimed in claim 15, wherein said electronic program guide system is incorporated in an integrated receiver decoder.

18. The electronic program guide system as claimed in claim 15, wherein said electronic program guide system is incorporated in a set-top box.

19. The electronic program guide system as claimed in claim 15, wherein said electronic program guide system is incorporated in a mobile handset.

20. The electronic program guide system as claimed in claim 15, wherein said electronic program guide system is incorporated in a television receiver.

21. The electronic program guide system as claimed in claim 15, wherein said electronic program guide system is incorporated in a mobile display appliance.

22. A method for browsing programs selected for display in a second display area of an electronic program guide system associated with a broadcast receiver comprising the steps of:
receiving at least one electronic program guide corresponding to a broadcast system;
generating display of said electronic program guide in a first display area of a display unit associated with said broadcast receiver;
selecting a desired program from said electronic program guide;
controlling a tuner of the associated broadcast receiver to tune to the selected program;
generating display of the selected program in the second display area of s aid display unit;
storing parameters identifying said selected program;
repeating the controlling, generating and storing steps for each subsequently made program selection.

23. A method as claimed in claim 22, further comprising the steps of:
selecting stored parameters identifying a previously selected program;
controlling a tuner of the associated broadcast receiver to tune to the program identified by the selected parameters;
generating display of the program identified by the selected parameters in the second display area of said display unit.

24. A method as claimed in claim 22, further comprising the step of:
selecting the program currently being displayed in the second display area of the display unit for full screen display.

25. A method as claimed in claim 22, further comprising the step of:
generating display of a list of the programs stored in the storage means in a third display area of the display unit.

26. A method as claimed in claim 23, further comprising the step of:
inputting stepwise sequential selection of the stored parameters.

27. A method as claimed in claim 25, further comprising the steps of:
selecting a program from said list;
controlling a tuner of the associated broadcast receiver to tune to the program selected;
generating display of the program selected in the second display area of said display unit.

28. A method as claimed in claim 25, further comprising the steps of:
selecting from said list a program currently being displayed in the second display area of the display unit;
generating full screen display of the selected program on the display unit.

29. A method as claimed in claim 22, further comprising the steps of:
activating timer means upon program selection; controlling a tuner of the associated broadcast receiver to tune to the selected program for a predetermined time; generating display of the selected program in the second display area of said display unit for the predetermined time ;
controlling the tuner of the associated broadcast receiver to tune to the previously selected program upon elapse of the predetermined time;
generating display of the previously selected program in the second display area of said display unit upon elapse of the predetermined time.

30. A method as claimed in claim 29, further comprising the steps of:
selecting the program being displayed in the second display area of the display unit for the predetermined time;
generating full screen display of the selected program on the display unit.

31. A method for browsing programs selected for display in a second display area of an electronic program guide system associated with a broadcast receiver comprising the steps of:
receiving at least one electronic program guide corresponding to a broadcast system;
generating display of said electronic program guide in a first display area of a display unit associated with said broadcast receiver;
selecting a desired program from said electronic program guide;
controlling a tuner of the associated broadcast receiver to tune to the selected program;
generating display of the selected program in the second display area of said display unit;
storing parameters identifying said selected program;
activating timer means upon additional program selection;
controlling a tuner of the associated broadcast receiver to tune to the additionally selected program for a predetermined time;
generating display of the additionally selected program in the second display area of said display unit for the predetermined time;
controlling the tuner of the associated broadcast receiver to tune to the previously selected program upon elapse of the predetermined time;
generating display of the previously selected program in the second display area of said display unit upon elapse of the predetermined time.

32. A method as claimed in claim 31, further comprising the steps of:
selecting the program being displayed in the second display area of the display unit for the predetermined time;
generating full screen display of the selected program on the display unit.

33. A computer program product stored on a computer readable storage medium, comprising computer readable program code means for causing a computer to perform the following steps:
receiving at least one electronic program guide corresponding to a broadcast system;
generating display of said electronic program guide in a first display area of a display unit;
providing for selection of a desired program from said electronic program guide;
controlling a tuner of an associated broadcast receiver to tune to the selected program;
generating display of the selected program in the second display area of said display unit;
storing parameters identifying said selected program;
providing for selection of an additional program from said electronic program guide;
repeating the controlling, generating and storing steps for each subsequent program selection;
providing for selection of stored parameters identifying a previously selected program;
controlling a tuner of the associated broadcast receiver to tune to the program identified by the selected parameters;
generating display of the program identified by the selected parameters in the second display area of said display unit.

34. A computer program product directly loadable into the internal memory of a digital computer comprising software code portions for performing the following steps when said product is run on a computer:
receiving at least one electronic program guide corresponding to a broadcast system;
generating display of said electronic program guide in a first display area of a display unit;
providing for selection of a desired program from said electronic program guide;
controlling a tuner of an associated broadcast receiver to tune to the selected program;
generating display of the selected program in the second display area of said display unit;
storing parameters identifying said selected program;
providing for selection of an additional program from said electronic program guide;
repeating the controlling, generating and storing steps for each subsequent program selection;
providing for selection of stored parameters identifying a previously selected program;
controlling a tuner of the associated broadcast receiver to tune to the program identified by the selected parameters;
generating display of the program identified by the selected parameters in the second display area of said display unit.
